(19) United States
(12) Patent Application Publication
(10) Pub. No.: US 2025/0175226 A1
(43) Pub. Date: May 29, 2025

(54) APPARATUSES AND METHODS FOR IMPROVING THE ACQUISITION OF CHANNEL STATE INFORMATION REPORT

(71) Applicant: MEDIATEK INC., Hsinchu City (TW)

(72) Inventors: Ming-Wang GUO, Hsinchu City (TW); Chao-Peng WANG, Hsinchu City (TW); Tsung-Han TSAI, Hsinchu City (TW)

(21) Appl. No.: 18/518,778

(22) Filed: Nov. 24, 2023

(51) Int. Cl. H04B 7/06; H04W 76/20

(52) U.S. Cl. CPC H04B 7/0626; H04W 76/20

(57) ABSTRACT

A method for obtaining channel state information (CSI) report is provided. The method is executed by a first wireless communication device and comprises: sending one Advance Channel State Information (ACSI) request frame to a second wireless communication device, wherein the ACSI request frame instructs the second wireless communication device to send a plurality of CSI report frames through a single link or multiple links respectively, and the ACSI request frame comprises information indicating a number of CSI report frames on the single link or each link in the multiple links; and receiving the plurality of CSI report frames from the second wireless communication device through the single link or the multiple links respectively.

### BACKGROUND OF THE INVENTION

### Field of the Invention

The present disclosure generally relates to wireless communications. More specifically, aspects of the present disclosure relate to apparatuses and methods for improving the acquisition of Channel State Information (CSI) report.

### Description of the Related Art

Understanding and correctly estimating the channel in an advance wireless communication system between a station (STA) and an access point (AP) is important for efficient and effective wireless communication. In order to correctly estimate the channel conditions, the STA may report (e.g., feedback) information about channel measurement, e.g., CSI, to the AP. With this information about the channel, the AP is able to select appropriate communication parameters to efficiently and effectively perform wireless data communication with the STA.

FIG. 1 is a schematic flowchart illustrating an AP 110 obtaining CSI sent from an STA 120 through request frames and acknowledgement (ACK) frames negotiation in the prior art. In FIG. 1, the AP 110 sends a first request frame for CSI to the STA 120 in step S105. In response to receiving the first request frame, the STA 120 sends a first ACK frame with the CSI to the AP 110 in step S110. Then, the AP 110 sends a second request frame for CSI to the STA 120 in step S115. In response to receiving the second request frame, the STA 120 sends a second ACK frame with the CSI to the AP 110 in step S120.

Subsequently, the AP sends the remaining request frames to the STA as in steps S105 and S115 until the final nth CSI request frame is sent in step S125 to the STA. In S130, the STA sends an nth ACK frame to the AP. The AP 110 can detect changes in the environment to perform other applications according to the obtained CSI from the ACK frames. In FIG. 1, the AP needs to send a request frame to notify the STA to send an ACK frame. In other words, for each CSI training, it takes 2 frames, and for N times of CSI training, it takes 2N frames.

However, with increase in the numbers of antennas and channel paths of wireless communication devices, so too has the amount of feedback increased that may be needed to ideally estimate the channel. This additionally-desired channel feedback may create additional overheads, thus increasing air time and reducing the efficiency of the wireless communication.

Therefore, there is a need for apparatuses and methods for improving the acquisition of Channel State Information (CSI) report to solve this problem.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide apparatuses and methods for improving the acquisition of Channel State Information (CSI) report to enable the AP and the STA to apply CSI and do CSI training in batch mode over multiple links to save air-time.

In an exemplary embodiment, a method for obtaining channel state information (CSI) report is provided. The method is executed by a first wireless communication device, and comprises: sending one Advance Channel State Information (ACSI) request frame to a second wireless communication device, wherein the ACSI request frame instructs the second wireless communication device to send a plurality of CSI report frames through a single link or multiple links respectively, and the ACSI request frame comprises information indicating a number of CSI report frames on the single link or each link in the multiple links; and receiving the plurality of CSI report frames from the second wireless communication device through the single link or the multiple links respectively.

In some embodiments, the method further comprises: sending a first management frame to the second wireless communication device, wherein the first management frame comprises a first specific information element (IE) indicating the first wireless communication device has an ACSI communication capability; and receiving a second management frame from the second wireless communication device, wherein the second management frame comprises a second specific IE indicating that the second wireless communication device has the ACSI communication capability.

In some embodiments, the method further comprises: assigning a timestamp for each of the CSI report frames, wherein the timestamp represents the time when the each of the CSI report frames is received at the first wireless communication device through the corresponding link; and arranging the CSI report frames in chronological order according to the timestamps for the CSI report frames.

In some embodiments, the ACSI request frame comprises a field indicating that it is an ACSI request frame.

In some embodiments, the ACSI request frame further comprises time information for indicating time when the CSI report is sent on the corresponding link and the information for indicating the number of CSI report sent on the corresponding link, wherein time information comprises a target time when a first CSI report frame is sent on the corresponding link, a time interval between two consecutive CSI report frames on the corresponding link.

In some embodiments, the ACSI request frame further comprises at least one of a number of streams field, bandwidth (BW) field, Modulation and Coding Scheme (MCS) field, wherein the number of streams field comprises a value indicating the number of streams for transmitting each CSI report frame on the corresponding link, the BW field comprises a value indicating the BW used by the second wireless communication device for transmitting each CSI report frame on the corresponding link, and the MCS field comprises a value indicating the MCS rate for transmitting each CSI report frame on the corresponding link.

In some embodiments, the multiple links comprise a first link, a second link and a third link, and the plurality of CSI report frames are received from the second wireless communication device cyclically in an order of the first link, the second link, and the third link.

In an exemplary embodiment, a method for obtaining channel state information (CSI) report is provided. The method is executed by a first wireless communication device, and comprises: receiving one Advance Channel State Information (ACSI) request frame from a second wireless communication device, wherein the ACSI request frame instructs the first wireless communication device to send a plurality of channel state information (CSI) report frames through a single link or multiple links respectively, and the ACSI request frame comprises information indicating a number of CSI report on the single link or each link in the multiple links; and sending the plurality of CSI report frames to the second wireless communication device according to the ACSI request frame through the single link or the multiple links respectively.

In some embodiments, the method further comprises: sending a first management frame to the second wireless communication device, wherein the first management frame comprises a first specific IE indicating the first wireless communication device has an ACSI communication capability; and receiving a second management frame from the second wireless communication device, wherein the second management frame comprises a second specific IE indicating that the second wireless communication device has the ACSI communication capability.

In some embodiments, the multiple links comprise a first link, a second link and a third link, and the plurality of CSI report frames are sent to the second wireless communication device cyclically in an order of the first link, the second link, and the third link.

In an exemplary embodiment, a wireless communication device is provided. The wireless communication device comprises a wireless transceiver and a controller. The wireless transceiver is configured to perform wireless transmission and reception to and from a second wireless communication device. The controller is coupled to the wireless transceiver and operable to configure the wireless communication device to send one Advance Channel State Information (ACSI) request frame to the second wireless communication device via the wireless transceiver, wherein the ACSI request frame instructs the second wireless communication device to send a plurality of channel state information (CSI) report frames through a single link or multiple links respectively and the ACSI request frame comprises information indicating a number of CSI report frames on the single link or each link in the multiple links, and receive the plurality of CSI report frames from the second wireless communication device through the single link or the multiple links respectively via the wireless transceiver.

In an exemplary embodiment, a wireless communication device is provided. The wireless communication device comprises a wireless transceiver and a controller. The wireless transceiver is configured to perform wireless transmission and reception to and from a second wireless communication device. The controller is coupled to the wireless transceiver, and operable to receive one Advance Channel State Information (ACSI) request frame from the second wireless communication device via the wireless transceiver, wherein the ACSI request frame instructs the wireless communication device to send a plurality of channel state information (CSI) report frames through a single link or multiple links respectively and the ACSI request frame comprises information indicating a number of CSI report on the single link or each link in the multiple links, and send the plurality of CSI report frames to the second wireless communication device according to the ACSI request frame through the single link or the multiple links respectively via the wireless transceiver.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic flowchart illustrating an AP obtaining CSI sent from an STA through request frames and acknowledgement (ACK) frames negotiation in the prior art.

FIG. 2A is a block diagram illustrating the connection between an Access Point (AP) and a station (STA) in a Wi-Fi 2/3/4/5/6 environment according to an embodiment of the disclosure.

FIG. 2B is a block diagram illustrating the connection between an AP and an STA in a Wi-Fi 7 environment according to an embodiment of the disclosure.

FIG. 3 is a block diagram illustrating the STA and the AP according to an embodiment of the disclosure with reference to FIGS. 2A˜2B.

FIG. 4 is a message sequence chart illustrating the AP and the STA discovering each other having an ACSI communication capability according to an embodiment of the disclosure.

FIG. 5 is a schematic diagram illustrating the format of a specific IE according to an embodiment of the disclosure.

FIG. 6 is a message sequence chart illustrating the AP communicating with the STA through a single link to obtain CSI report frames in the Wi-Fi 2/3/4/5/6 environment according to an embodiment of the disclosure.

FIGS. 7A˜7B are schematic diagrams illustrating the AP communicating with the STA through multiple links to obtain CSI report frames in the Wi-Fi 7 environment according to an embodiment of the disclosure.

FIG. 8 is a schematic diagram illustrating the AP assigning timestamps for the CSI report frames sent from the STA in the Wi-Fi 7 environment according to an embodiment of the disclosure.

FIGS. 9A˜9B are schematic diagrams illustrating the format of an ACSI request frame according to an embodiment of the disclosure.

FIG. 10 is a schematic diagram illustrating the format of a CSI report frame according to an embodiment of the disclosure.

FIG. 11 is a flow chart illustrating the method for obtaining channel state information (CSI) report according to an embodiment of the disclosure.

FIG. 12 is a flow chart illustrating the method for sending channel state information (CSI) report according to an embodiment of the disclosure.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

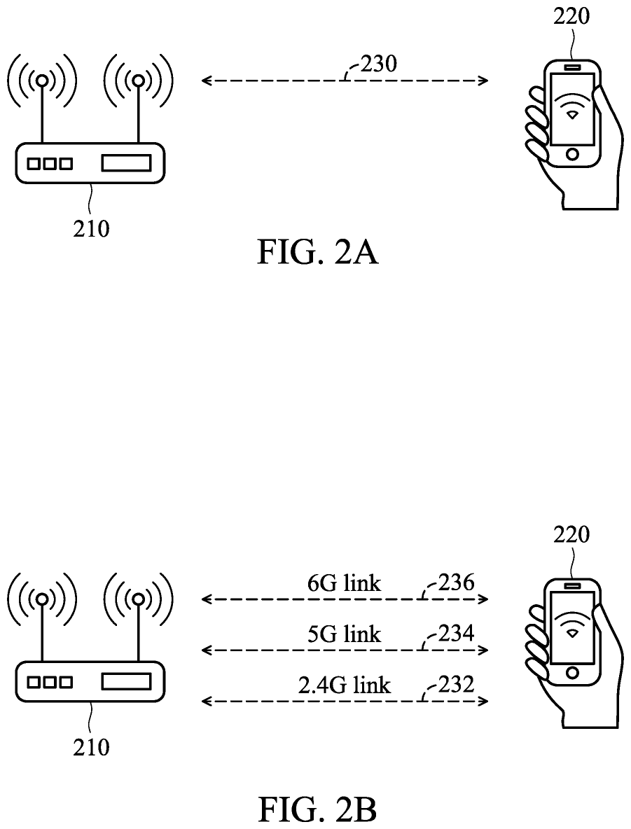

FIG. 2A is a block diagram illustrating the connection between an Access Point (AP) and a station (STA) in a Wi-Fi 2/3/4/5/6 environment according to an embodiment of the disclosure. In FIG. 2A, the STA 220 setups a connection via a single link 230 with the AP 210.

FIG. 2B is a block diagram illustrating the connection between an AP and an STA in a Wi-Fi 7 environment according to an embodiment of the disclosure. In FIG. 2B, the STA 220 setups a connection via multiple links with the AP 210, wherein the multiple links can be a 2.4G link 232, a 5G link 234 and a 6G link 236.

In FIGS. 2A˜2B, the AP 210 is an entity compatible with an IEEE 802.11 standard. Each of the STAs 120-140 may be stationary, mobile, or a combination thereof.

The STA 220 may be a mobile phone (e.g., feature phone or smartphone), an wearable electronic (e.g., smart watch or smart glass), a panel Personal Computer (PC), a laptop computer, or any wireless communication terminal, as long as it is compatible with the same IEEE 802.11 standard as the AP 210.

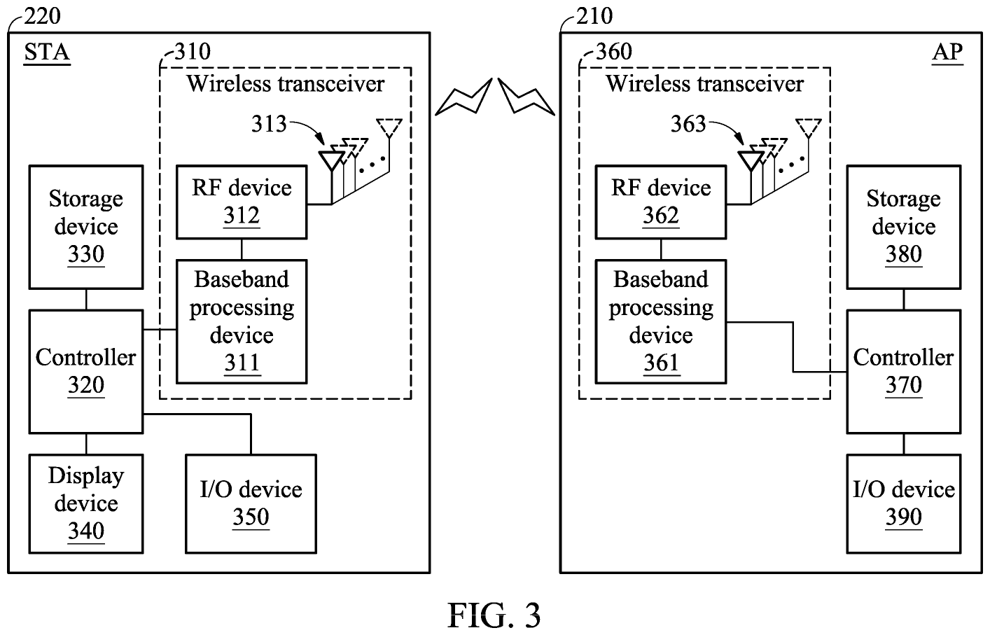

FIG. 3 is a block diagram illustrating the STA 220 and the AP 210 according to an embodiment of the disclosure with reference to FIGS. 2A˜2B.

As shown in FIG. 3, the STA 220 may include a wireless transceiver 310, a controller 320, a storage device 330, a display device 340, and an Input/Output (I/O) device 350.

The wireless transceiver 310 is configured to perform wireless transmission and reception to and from the AP 210. For example, the wireless transceiver 310 may be a Wi-Fi chip.

Specifically, the wireless transceiver 310 may include a baseband processing device 311, a Radio Frequency (RF) device 312, and antenna 313, wherein the antenna 313 may include an antenna array for UL/DL Multi-User Multiple Input-Multiple-Output (MU-MIMO).

The baseband processing device 311 is configured to perform baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may also contain multiple hardware devices to perform radio frequency conversion. For example, the RF device 312 may include a mixer to multiply the baseband signals with a carrier oscillated in the radio frequency of the supported cellular technologies, wherein the radio frequency may be 2.4 GHz, 5 GHz, or 6 GHz utilized in the Wi-Fi technology, or any radio frequency utilized in the future evolution of the Wi-Fi technology.

The controller 320 may be a general-purpose processor, a Micro Control Unit (MCU), an application processor, a Digital Signal Processor (DSP), or the like, which includes various circuits for providing the functions of data processing and computing, controlling the wireless transceiver 310 for wireless communications with the AP 210, storing and retrieving data (e.g., program code) to and from the storage device 330, sending a series of frame data to the display device 340, and receiving user inputs or outputting signals via the I/O device 350.

In particular, the controller 320 coordinates the aforementioned operations of the wireless transceiver 310, the storage device 330, the display device 340, and the I/O device 350 for performing the method of the present disclosure.

In another embodiment, the controller 320 may be incorporated into the baseband processing device 311, to serve as a baseband processor.

The storage device 330 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, the Wi-Fi protocol (of the IEEE 802.11be or another protocol version), and/or the method of the present disclosure.

The display device 340 may be a Liquid-Crystal Display (LCD), a Light-Emitting Diode (LED) display, an Organic LED (OLED) display, or an Electronic Paper Display (EPD), etc., for providing a display function.

The I/O device 350 may include one or more buttons, a keyboard, a mouse, a touch pad, a video camera, a microphone, and/or a speaker, etc., to serve as the Man-Machine Interface (MMI) for interaction with users.

Similarly, the AP 210 may include a wireless transceiver 360, a controller 370, a storage device 380, and an I/O device 390.

The wireless transceiver 360 is configured to perform wireless transmission and reception to and from the STA 220. For example, the wireless transceiver 360 may be a Wi-Fi chip.

Specifically, the wireless transceiver 360 may include a baseband processing device 361, an RF device 362, and antenna 363, wherein the antenna 363 may include an antenna array for UL/DL MU-MIMO.

The baseband processing device 361 is configured to perform baseband signal processing.

The RF device 362 may receive RF wireless signals via the antenna 363, convert the received RF wireless signals to baseband signals, which are processed by the baseband processing device 361, or receive baseband signals from the baseband processing device 361 and convert the received baseband signals to RF wireless signals, which are later transmitted via the antenna 363. The RF device 362 may also contain multiple hardware devices to perform radio frequency conversion. For example, the RF device 362 may include a mixer to multiply the baseband signals with a carrier oscillated in the radio frequency of the supported cellular technologies, wherein the radio frequency may be 2.4 GHz, 5 GHz, or 6 GHz utilized in the Wi-Fi technology, or any radio frequency utilized in the future evolution of the Wi-Fi technology.

The controller 370 may be a general-purpose processor, an MCU, an application processor, a DSP, or the like, which includes various circuits for providing the functions of data processing and computing, controlling the wireless transceiver 360 for wireless communications with the STA 220, storing and retrieving data (e.g., program code) to and from the storage device 380, and receiving user inputs or outputting signals via the I/O device 390.

In particular, the controller 370 coordinates the aforementioned operations of the wireless transceiver 360, the storage device 380, and the I/O device 390 for performing the method of the present disclosure.

In another embodiment, the controller 370 may be incorporated into the baseband processing device 361, to serve as a baseband processor.

As will be appreciated by persons skilled in the art, the circuits of the controllers 320 and 370 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 380 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, Wi-Fi protocol (of the IEEE 802.11be or another protocol version), and/or the method of the present application.

The I/O device 390 may include one or more buttons, a keyboard, a touch pad, a display device (e.g., LCD, LED, OLED, or EPD, etc.), a light emitting device, a microphone, and/or a speaker, etc., to serve as the MMI for interaction with users.

It should be understood that the components described in the embodiment of FIG. 3 are for illustrative purposes only and are not intended to limit the scope of the disclosure. The AP 210 or the STA 220 may include fewer components. For example, the STA 220 may not include the display device 340 and/or the I/O device 350.

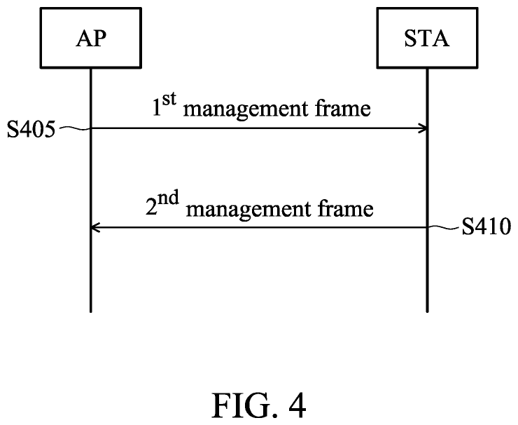

FIG. 4 is a message sequence chart illustrating the AP and the STA discovering each other having an ACSI communication capability according to an embodiment of the disclosure.

It should be noted that, as used herein, the term “ACSI communication capability” indicates a device's ability to send one request frame to trigger another device to send multiple CSI reports on a single link or on each link in a plurality of links, and/or the another device's ability to send multiple CSI reports in response to receiving the one request frame on the single link or on each link in the plurality of links.

In step S405, the AP sends a first management frame to the STA, wherein the first management frame comprises a first specific information element (IE) indicating the AP has an ACSI communication capability, and the first management frame can be a probe request, an associate request, or a beacon.

In step S410, the AP receives a second management frame from the STA, wherein the second management frame comprises a second specific IE indicating that the STA has the ACSI communication capability, and the second management frame can be a probe response, an associate response, or a beacon.

When the AP knows that the STA has the ACSI communication capability, the AP enables the ACSI feature between the AP and the STA. On the other hand, when the STA knows that the AP has the ACSI communication capability, the STA enables the ACSI feature between the AP and the STA.

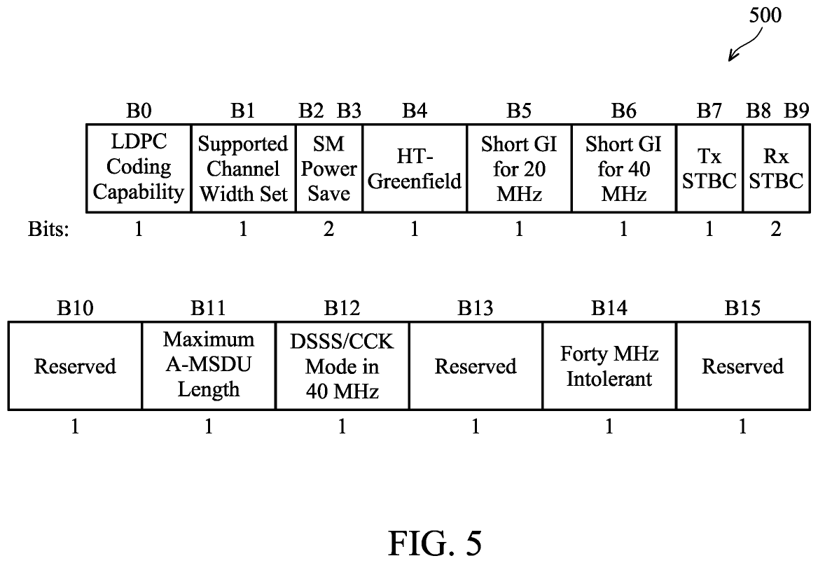

FIG. 5 is a schematic diagram illustrating the format of a specific IE according to an embodiment of the disclosure. The specific IE including information regarding the ACSI communication capability of the AP or the STA. Referring to FIG. 5, the specific IE may include an HT capabilities information field 500, but the disclosure is not limited thereto. In one embodiment, the HT capabilities information field comprises a reserved field B15 indicating whether the AP or the STA supports the ACSI communication capability. For example, but not limited to, when the reserved field B15 is set to “1”, the specific IE indicates that the AP or the STA supports ACSI communication capability. When the reserved field B15 is set to “0”, the specific IE indicates that the AP or the STA does not support ACSI communication capability.

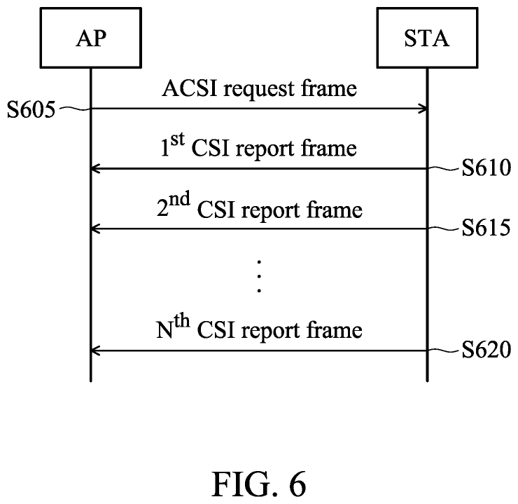

FIG. 6 is a message sequence chart illustrating the AP communicating with the STA through a single link to obtain CSI report frames in the Wi-Fi 2/3/4/5/6 environment according to an embodiment of the disclosure.

Before the message sequence chart starts, it is assumed that the AP and the STA have discovered that each other has the ACSI communication capability described in FIGS. 4˜5.

In step S605, the AP sends an Advance Channel State Information (ACSI) request frame to the STA, wherein the ACSI request frame instructs the STA to send a plurality of channel state information (CSI) report frames through a single link, wherein the ACSI request frame comprises time information for indicating time when the CSI report is sent and information for indicating a number of CSI report frames on the single link.

In step S610, the STA sends a first CSI report frames to the AP according to the ACSI request frame through the single link.

In step S615, the STA sends a second CSI report frames to the AP according to the ACSI request frame through the single link.

Subsequently, the STA sends the remaining CSI report frames to the AP according to the ACSI request frame until the final N^{th} CSI report frame is sent in step S620 to the AP.

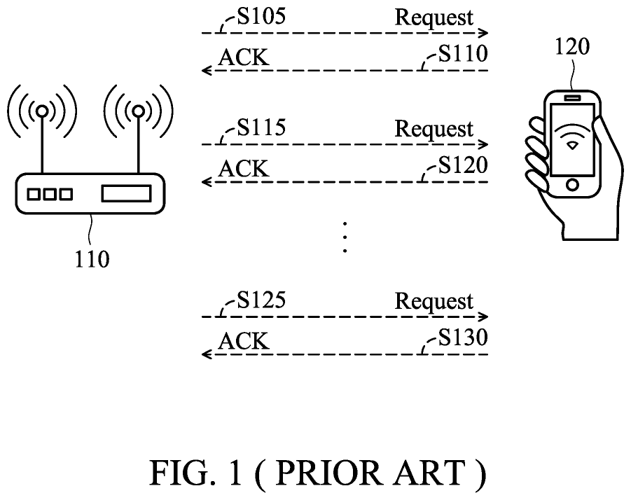

Obviously, in FIG. 6, the AP merely needs to send one ACSI request frame to the STA, wherein the ACSI request frame includes the information required by the STA to send the CSI report frames. The STA does not need to wait for the AP to send other request frames, and can respectively send the CSI report frames to the AP at different predetermined times according to the time information of the ACSI request frame. Compared with the prior art in FIG. 1, for N times of CSI training, it only needs to take “N+1” frames, effectively achieving the purpose of reducing overhead.

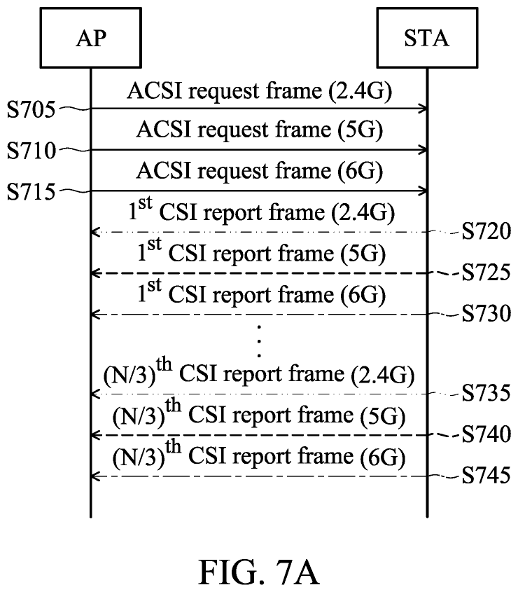

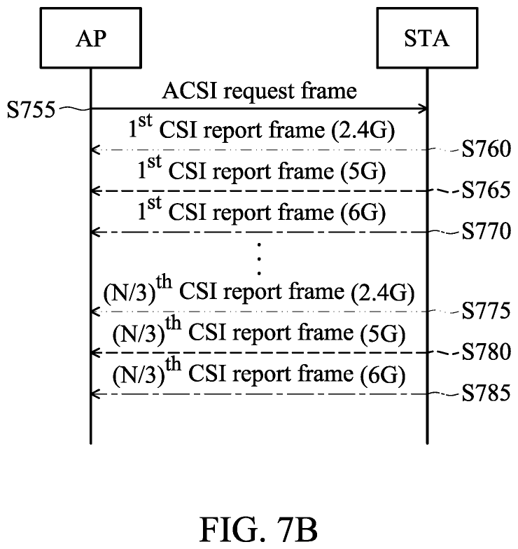

FIG. 7A˜7B are schematic diagrams illustrating the AP communicating with the STA through multiple links to obtain CSI report frames in the Wi-Fi 7 environment according to an embodiment of the disclosure.

As shown in FIG. 7A, the AP transmits ACSI request frames to the STA through the 2.4G link, the 5G link and the 6G link in steps S705, S710, and S715 respectively, wherein the ACSI request frame through the 2.4G link comprises time information for instructing the STA to send CSI report frames to the AP at specific times through the 2.4G link, and information indicating a number of CSI report frames on the 2.4G link, the ACSI request frame through the 5G link comprises time information for instructing the STA to send CSI report frames to the AP at specific times through the 5G link, and information indicating a number of CSI report frames on the 5G link, the ACSI request frame through 6G link comprises time information for instructing the STA to send CSI report frames to the AP at specific times through the 6G link, and information indicating a number of CSI report frames on the 6G link. In one embodiment, steps S705, S710, and S715 may be performed by the AP at the same time or at different times. In response to receiving the ACSI request frames sent by the AP, the STA respectively sends a first CSI report frame to the AP through the 2.4G link, 5G link, and 6G link in steps S720, S725, and S730 according to the ACSI request frames received in steps S705, S710, and S715. In one embodiment, steps S720, S725, and S730 are performed by the STA according to the time information in the ACSI request frames received in steps S705, S710, and S715.

Subsequently, the STA respectively sends the remaining CSI report frames to the AP through the 2.4G link, 5G link and 6G link until the final (N/3)^{th} CSI report frames are sent in steps S735, S740 and S745 to the AP.

In the prior art of FIG. 1, the AP 110 and the STA 120 transmit the requests and ACKs with each other through one link. Compared with the prior art of FIG. 1, the AP and the STA in FIG. 7A transmits the ACSI request frame and the CSI report frames with each other through 2.4G link, 5G link, and 6G link, respectively. Each link only needs to transmit one-third of the total number of CSI report frames, effectively reducing the overhead of each link. Furthermore, for each link, compared with the prior art in FIG. 1, for N times of CSI training, it only needs to take “N/3+1” frames through each link, further effectively reducing the overhead of each link.

FIG. 7B is another embodiment illustrating the AP communicating with the STA through multiple links to obtain CSI report frames in the Wi-Fi 7 environment. In FIG. 7B, the AP transmits one ACSI request frame to the STA in step S755, wherein the ACSI request frame can be sent on one of the 2G link, 5G link and 6G link, and the ACSI request frame comprises time information for indicating that the STA sends CSI report frames to the AP at specific times through the 2.4G link, 5G link and 6G link respectively, and information for indicating a number of CSI report on the 2.4G link, 5G link and 6G link respectively. In response to receiving the ACSI request frames sent by the AP, the STA respectively sends a first CSI report frame to the AP through the 2.4G link, 5G link, and 6G link in steps S760, S765, and S770 according to the ACSI request frame received in step S755. In one embodiment, steps S760, S765, and S770 are performed by the STA according to the time information in the ACSI request frame received in step S755.

Subsequently, the STA respectively sends the remaining CSI report frames to the AP cyclically in an order of the 2.4G link, 5G link and 6G link until the final (N/3)^{th} CSI report frames are sent in steps S775, S780 and S785 to the AP.

In the prior art of FIG. 1, the AP 110 and the STA 120 transmit the requests and ACKs with each other through one link. Compared with the prior art of FIG. 1, the AP in FIG. 7B transmits the ACSI request frame on one of 2.4G link, 5G link, and 6G link and receives CSI report frames through 2.4G link, 5G link, and 6G link, respectively. Each link only needs to transmit one-third of the total number of CSI report frames, effectively reducing the overhead of each link. Furthermore, compared with the prior art in FIG. 1, for N times of CSI training, it only need transfer one ACSI request frame through any link in 2.4G link, 5G link, and 6G link and transfer N/3 CSI report frame through each link, further effectively reducing the overhead of each link.

In addition, in FIGS. 7A and 7B, when a CSI report frame is transmitted through a link, other links that are not used to transmit the CSI report frames can be used to transmit data. For example, when the CSI report frames are transmitted through the 5G link and the 6G link, data can be transmitted on the 2.4G link.

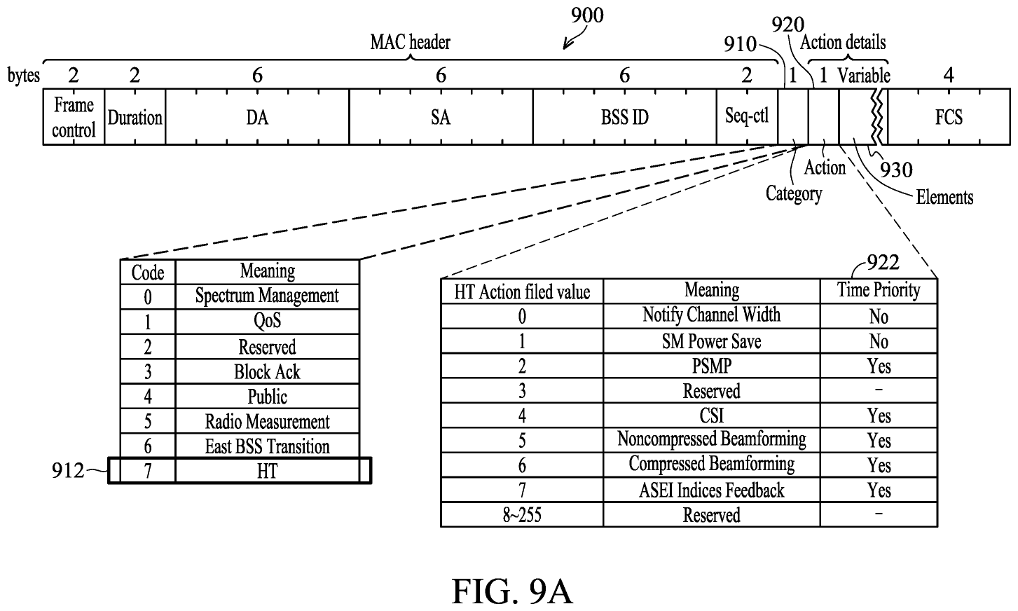

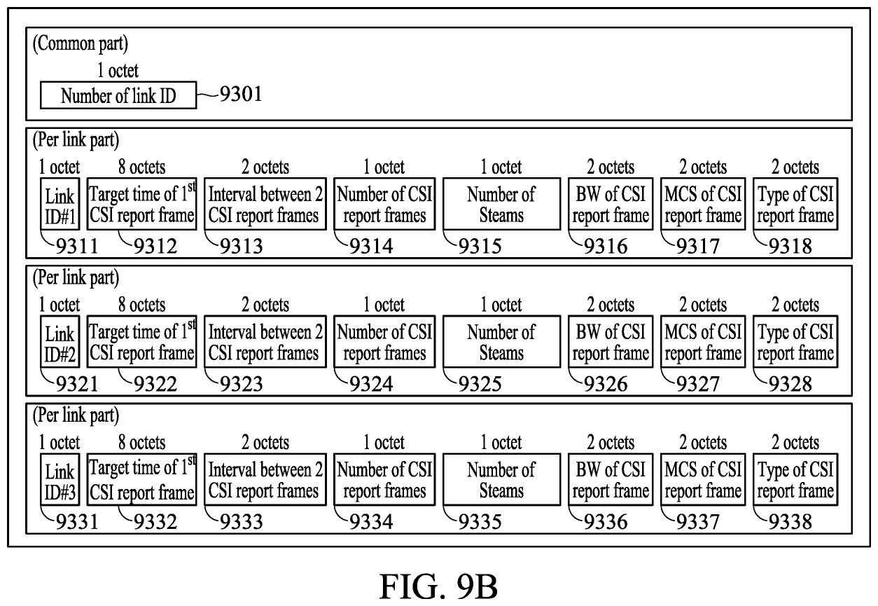

In addition, the time information in the ACSI request frames received in steps S705, S710, and S715 of FIG. 7A may comprise a target time when the first CSI report frame is sent on the corresponding link, and a time interval between two consecutive CSI report frames on the corresponding link. The time information in the ACSI request frames received in step S755 of FIG. 7B may comprise a target time when the first CSI report frame is sent on 2.4G link, an time interval between two consecutive CSI report frames on 2.4G link, a target time when the first CSI report frame is sent on 5G link, an time interval between two consecutive CSI report frames on 5G link, a target time when the first CSI report frame is sent on 6G link, and an time interval between two consecutive CSI report frames on 6G link. The detailed description of the specific time information is described in FIG. 9B.

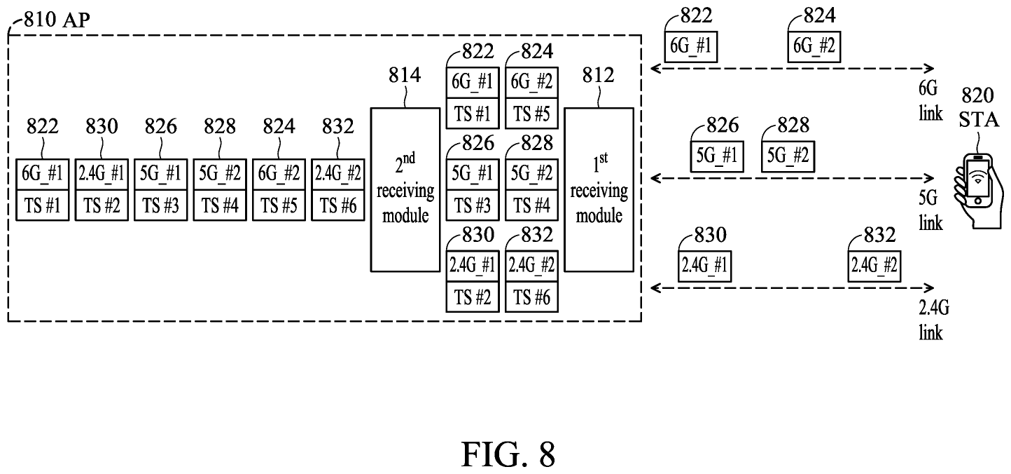

FIG. 8 is a schematic diagram illustrating the AP assigning timestamps for the CSI report frames sent from the STA in the Wi-Fi 7 environment according to an embodiment of the disclosure.

In FIG. 8, the AP 810 may include a first receiving module 812 and a second receiving module 814. It should be noted that the first receiving module 812 and the second receiving module 814 in FIG. 8 may be implemented in hardware, software, firmware, or any combination thereof. For example, the first receiving module 812 and the second receiving module 814 may be implemented as computer program code configured to be executed in one or more processors, such as the controller 370 of FIG. 3. Alternatively, the first receiving module 812 and the second receiving module 814 may be implemented as hardware logic/electrical circuitry.

In response to receiving the ACSI request frames transmitted from the AP 810, the STA 820 transmits CSI report frames to the AP 810 through the 2.4G link, 5G link and 6G link at different times according to the ACSI request frames. As shown in FIG. 8, the STA 820 transmits the CSI report frames 822 and 824 to the AP 810 through the 6G link, the STA 820 transmits the CSI report frames 826 and 828 to the AP 810 through the 5G link, and the STA 820 transmits the CSI report frames 830 and 832 through the 2.4G link to the AP 810.

When the AP 810 receives the CSI report frames transmitted from the STA 820, the AP 810 assigns a timestamp for each of the CSI report frames, wherein the timestamp represents the time when each of the CSI report frames is received at the AP 810 through the corresponding link. For example, in FIG. 8, the first receiving module 812 of the AP 810 sequentially assigns timestamps (TS) #1˜#6 for the CSI report frames 822, 830, 826, 828, 824 and 832.

Then, the second receiving module 814 of the AP 810 sends the CSI report frames 822, 830, 826, 828, 824 and 832 in chronological order to the upper layer according to the timestamps TS #1˜#6 for the CSI report frames. The upper layer can utilize the CSI report frames 822, 830, 826, 828, 824 and 832 in chronological order to measure, wherein the upper layer may be the application layer. For example, the upper layer can utilize the CSI report frames 822, 830, 826, 828, 824 and 832 in chronological order to measure so that the user's motion can be measured correctly.

Alternatively, in one embodiment, the STA 820 can assign a timestamp for each of the CSI report frames, wherein the timestamp represents the time when each of the CSI report frames is sent from the STA 820. For example, the CSI report frames 822 and 824 include timestamps 6G_#1 and 6G_#2, respectively, the CSI report frames 826 and 828 include timestamps 5G_#1 and 5G_#2, respectively, and the CSI report frames 830 and 832 include timestamps 2.4G_#1 and 2.4G_#2, respectively. It should be noted that although the Wi-Fi 7 is used in this example as an illustration, it is not limited to the disclosure.

FIGS. 9A˜9B are a schematic diagram illustrating the format of an ACSI request frame 900 according to an embodiment of the disclosure.

As shown in FIG. 9A, the category field 910 and the action field 920 may be set to indicate that the relevant frame is the ACSI request frame 900. In one embodiment, the category field 910 may indicate an HT category 912. Corresponding to the HT category 912, the action field 920 may include the HT action field 922, wherein one of the reserved values 8˜255 may be set to indicate the ACSI request frame. For example, but not limited to, one of the reserved values 8˜255 set to “10” indicates that the relevant frame is the ACSI request frame 900.

In one embodiment, the elements field 930 of the ACSI request frame may contain various information required by the STA for sending the CSI report frames. For example, in FIG. 9B, the elements field 930 may contain a number of link IDs field 9301, link ID fields 9311, 9321 and 9331, target time fields of the first CSI report frame 9312, 9322 and 9332, interval fields between two CSI report frames 9313, 9323 and 9333, a number of the CSI report frames fields 9314, 9324 and 9334, a number of streams fields 9315, 9325 and 9335, bandwidth (BW) fields of the CSI report frame 9316, 9326 and 9336, Modulation and Code Scheme (MCS) fields of the CSI report frame 9317, 9327 and 9337, and type fields of the CSI report frame 9318, 9328 and 9338. In the embodiment, the time unit is microsecond.

The number of link IDs field 9301 can comprise a value indicating the number of link IDs which the STA uses. Each of the link ID fields 9311, 9321 and 9331 can comprise a link ID value of the link, such as 2.4G link, 5G link or 6G link. Each of the target time fields 9312, 9322 and 9332 of the first CSI report frame can comprise a target time when the first CSI report frame is sent by the AP on respective link. Each of the interval fields 9313, 9323 and 9333 between two CSI report frames can comprise a time interval between two consecutive CSI report frames sent by the AP on respective link. Each of the number of the CSI report frames fields 9314, 9324 and 9334 can comprise a value indicating the number of total CSI report frames the STA needs to send on respective link. Each of the number of streams fields 9315, 9325 and 9335 can comprise a value indicating the number of streams for transmitting each CSI report frame on corresponding link. Each of Bandwidth (BW) fields 9316, 9326 and 9336 of the CSI report frame can comprise a value indicating the BW used by the STA on respective link. Each of Modulation and Coding Scheme (MCS) fields 9317, 9327 and 9337 of the CSI report frame can comprise a value indicating the MCS rate on respective link. Each of type fields 9318, 9328 and 9338 of the CSI report frame can indicate the type of the CSI report frame on respective link, such as ACK frame or other frame defined in the IEEE 802.11 standard.

With this arrangement, the AP can set the transmission rules for CSI report based on changes in the network environment. For example, when the available bandwidth in the network is narrow, a smaller bandwidth can be used to transmit CSI reports.

It should be noted that although the details of the ACSI request frame 900 are illustrated in FIGS. 9A˜9B, it should not be limited in the disclosure, and those skilled in the art can make appropriate replacements or adjustments according to this embodiment.

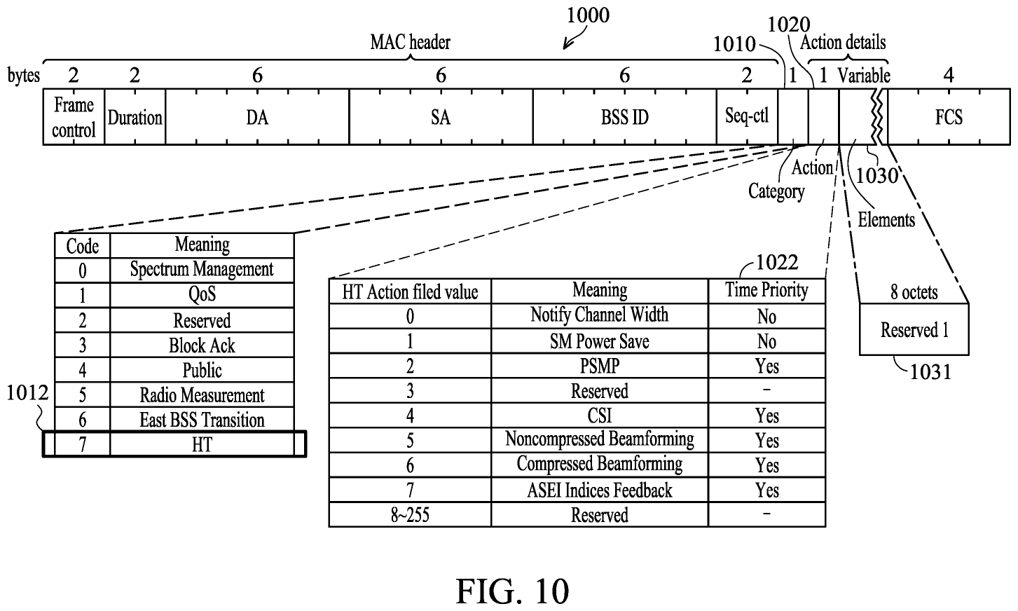

FIG. 10 is a schematic diagram illustrating the format of a CSI report frame 1000 according to an embodiment of the disclosure.

As shown in FIG. 10, a category field 1010 and an action field 1020 may be set to indicate that the relevant frame is the CSI report frame 1000. In one embodiment, the category field 1010 may indicate an HT category 1012. Corresponding to the HT category 1012, the action field 1020 may include the HT action field 1022, wherein one of the reserved values 8-255 may be set to indicate the CSI report frame. For example, but not limited to, one of the reserved values 8-255 set to “11” indicates that the relevant frame is the CSI report frame 1000.

In one embodiment, an elements field 1030 of the CSI report frame 1000 may contain a reserved field 1031. The reserved field 1031 can include a timestamp representing the time when the CSI report frames is sent by the STA. In another embodiment, the CSI report frame can be a null data packet (NDP).

In addition, although the details of the CSI report frame 1000 are illustrated in FIG. 10, it should not be limited in the disclosure, and those skilled in the art can make appropriate replacements or adjustments according to this embodiment.

It should be noted that although the AP and the STA are used as examples in FIGS. 2˜10, the STA can also be an AP in different network environments (for example, EasyMesh backhaul network or 802.11 mode) and it should not be limited in the embodiments shown in FIGS. 2˜4 and 6˜8 in the disclosure. Specifically, the method provided by the present disclosure can be applied between the AP and the STA, or between the AP and the AP, such as, between two network devices in a mesh network. In the mesh network, all the APs included in the mesh network are equal, and the objects sending the ACSI requests are not limited to the APs.

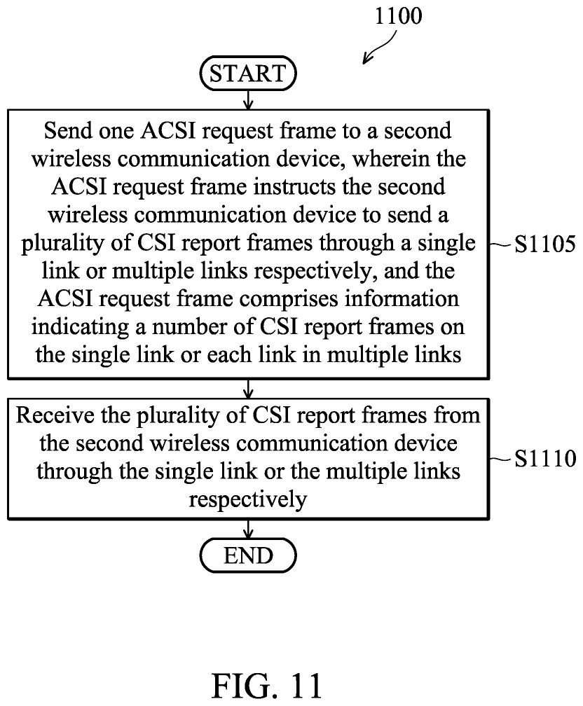

FIG. 11 is a flow chart 1100 illustrating the method for obtaining channel state information (CSI) report according to an embodiment of the disclosure, wherein the first wireless communication device operates as an AP.

In this embodiment, the method is applied to and executed by the first wireless communication device for improving CSI report transmission performance.

In step S1105, the first wireless communication device sends one ACSI request frame to a second wireless communication device, wherein the ACSI request frame instructs the second wireless communication device to send a plurality of CSI report frames through a single link or multiple links respectively, and the ACSI request frame comprises information indicating a number of CSI report frames on the single link or each link in multiple links. In this embodiment, the second wireless communication device is an STA or an AP.

In step S1110, the first wireless communication device receives the plurality of CSI report frames from the second wireless communication device through the single link or the multiple links respectively. In some embodiments, the plurality of CSI report frames received from the second wireless communication device comprise multiple CSI report frames received from each link in multiple links. In some embodiments, the multiple links comprise a first link, a second link and a third link, and the plurality of CSI report frames are received from the second wireless communication device cyclically in an order of the first link, the second link, and the third link.

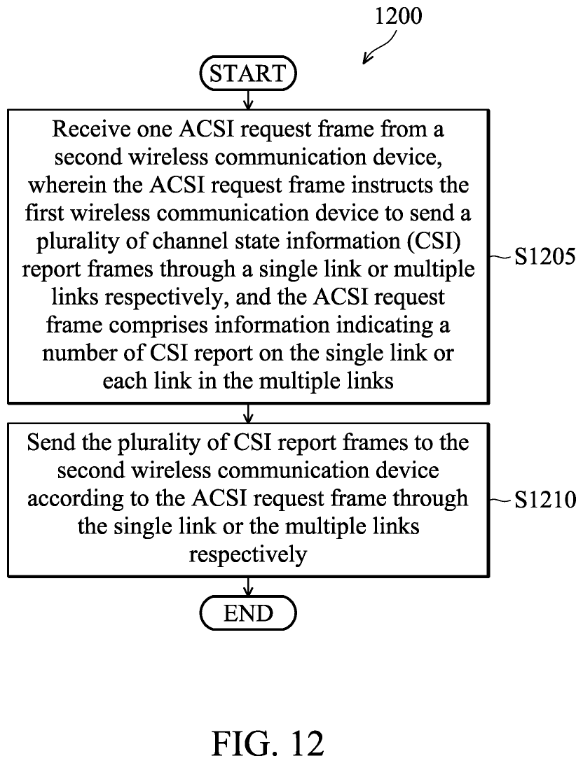

FIG. 12 is a flow chart 1200 illustrating the method for sending channel state information (CSI) report according to an embodiment of the disclosure.

In this embodiment, the method is applied to and executed by a first wireless communication device for improving CSI report transmission performance, and the first wireless communication device operates as an STA or an AP, and a second wireless communication device operates as an AP.

In step S1205, the first wireless communication device receives one ACSI request frame from the second wireless communication device, wherein the ACSI request frame instructs the first wireless communication device to send a plurality of channel state information (CSI) report frames through a single link or multiple links respectively, and the ACSI request frame comprises information indicating a number of CSI report on the single link or each link in the multiple links.

In step S1210, the first wireless communication device sends the plurality of CSI report frames to the second wireless communication device according to the ACSI request frame through the single link or the multiple links respectively.

In view of the forgoing embodiments, it will be appreciated that the present disclosure can apply multiple-links CSI report flow, and do CSI training in batch mode over multiple links. Advantageously, airtime is saved and overhead of per link is reduced.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for obtaining channel state information (CSI) report, executed by a first wireless communication device, the method comprising:
sending one Advance Channel State Information (ACSI) request frame to a second wireless communication device, wherein the ACSI request frame instructs the second wireless communication device to send a plurality of CSI report frames through a single link or multiple links respectively, and the ACSI request frame comprises information indicating a number of CSI report frames on the single link or each link in the multiple links; and
receiving the plurality of CSI report frames from the second wireless communication device through the single link or the multiple links respectively.

2. The method as claimed in claim 1, wherein before sending the ACSI request frame, the method further comprises:
sending a first management frame to the second wireless communication device, wherein the first management frame comprises a first specific information element (IE) indicating the first wireless communication device has an ACSI communication capability; and
receiving a second management frame from the second wireless communication device, wherein the second management frame comprises a second specific IE indicating that the second wireless communication device has the ACSI communication capability.

3. The method as claimed in claim 1, wherein the method further comprises:
assigning a timestamp for each of the CSI report frames, wherein the timestamp represents the time when the each of the CSI report frames is received at the first wireless communication device through the corresponding link; and
arranging the CSI report frames in chronological order according to the timestamps for the CSI report frames.

4. The method as claimed in claim 1, wherein the ACSI request frame comprises a field indicating that it is an ACSI request frame.

5. The method as claimed in claim 1, wherein the ACSI request frame further comprises time information for indicating time when the CSI report is sent on the corresponding link and the information for indicating the number of CSI report sent on the corresponding link, wherein time information comprises a target time when a first CSI report frame is sent on the corresponding link, a time interval between two consecutive CSI report frames on the corresponding link.

6. The method as claimed in claim 1, wherein the ACSI request frame further comprises at least one of a number of streams field, bandwidth (BW) field, Modulation and Coding Scheme (MCS) field, wherein the number of streams field comprises a value indicating the number of streams for transmitting each CSI report frame on the corresponding link, the BW field comprises a value indicating the BW used by the second wireless communication device for transmitting each CSI report frame on the corresponding link, and the MCS field comprises a value indicating the MCS rate for transmitting each CSI report frame on the corresponding link.

7. The method as claimed in claim 1, wherein the multiple links comprise a first link, a second link and a third link, and the plurality of CSI report frames are received from the second wireless communication device cyclically in an order of the first link, the second link, and the third link.

8. A method for sending channel state information (CSI) report, executed by a first wireless communication device, the method comprising:
receiving one Advance Channel State Information (ACSI) request frame from a second wireless communication device, wherein the ACSI request frame instructs the first wireless communication device to send a plurality of channel state information (CSI) report frames through a single link or multiple links respectively, and the ACSI request frame comprises information indicating a number of CSI report on the single link or each link in the multiple links; and
sending the plurality of CSI report frames to the second wireless communication device according to the ACSI request frame through the single link or the multiple links respectively.

9. The method as claimed in claim 8, wherein before receiving the ACSI request frame, the method further comprises:
sending a first management frame to the second wireless communication device, wherein the first management frame comprises a first specific IE indicating the first wireless communication device has an ACSI communication capability; and
receiving a second management frame from the second wireless communication device, wherein the second management frame comprises a second specific IE indicating that the second wireless communication device has the ACSI communication capability.

10. The method as claimed in claim 8, wherein the ACSI request frame comprises a field indicating that it is an ACSI request frame.

11. The method as claimed in claim 8, wherein the ACSI request frame further comprises time information for indicating time when the CSI report is sent on the corresponding link and the information for indicating a number of CSI report sent on the corresponding link, wherein time information comprises a target time when a first CSI report frame is sent on the corresponding link, a time interval between two consecutive CSI report frames on the corresponding link.

12. The method as claimed in claim 8, wherein the ACSI request frame further comprises at least one of a number of streams field, bandwidth (BW) field, Modulation and Coding Scheme (MCS) field, wherein the number of streams field comprises a value indicating the number of streams for transmitting each CSI report frame on the corresponding link, the BW field comprises a value indicating the BW used by the second wireless communication device for transmitting each CSI report frame on the corresponding link, and the MCS field comprises a value indicating the MCS rate for transmitting each CSI report frame on the corresponding link.

13. The method as claimed in claim 8, wherein the multiple links comprise a first link, a second link and a third link, and the plurality of CSI report frames are sent to the second wireless communication device cyclically in an order of the first link, the second link, and the third link.

14. A wireless communication device, comprising:
a wireless transceiver, configured to perform wireless transmission and reception to and from a second wireless communication device; and
a controller, coupled to the wireless transceiver, and operable to: send one Advance Channel State Information (ACSI) request frame to the second wireless communication device via the wireless transceiver, wherein the ACSI request frame instructs the second wireless communication device to send a plurality of channel state information (CSI) report frames through a single link or multiple links respectively and the ACSI request frame comprises information indicating a number of CSI report frames on the single link or each link in the multiple links, and receive the plurality of CSI report frames from the second wireless communication device through the single link or the multiple links respectively via the wireless transceiver.

15. The wireless communication device as claimed in claim 14, wherein the ACSI request frame further comprises time information for indicating time when the CSI report is sent on the corresponding link and the information for indicating the number of CSI report sent on the corresponding link, wherein time information comprises a target time when a first CSI report frame is sent on the corresponding link, a time interval between two consecutive CSI report frames on the corresponding link.

16. The wireless communication device as claimed in claim 14, wherein the ACSI request frame further comprises at least one of a number of streams field, bandwidth (BW) field, Modulation and Coding Scheme (MCS) field, wherein the number of streams field comprises a value indicating the number of streams for transmitting each CSI report frame on the corresponding link, the BW field comprises a value indicating the BW used by the second wireless communication device for transmitting each CSI report frame on the corresponding link, and the MCS field comprises a value indicating the MCS rate for transmitting each CSI report frame on the corresponding link.

17. The wireless communication device as claimed in claim 14, wherein the multiple links comprise a first link, a second link and a third link, and the plurality of CSI report frames are received from the second wireless communication device cyclically in an order of the first link, the second link, and the third link.

18. A wireless communication device, comprising:
a wireless transceiver, configured to perform wireless transmission and reception to and from a second wireless communication device; and
a controller, coupled to the wireless transceiver, and operable to: receive one Advance Channel State Information (ACSI) request frame from the second wireless communication device via the wireless transceiver, wherein the ACSI request frame instructs the wireless communication device to send a plurality of channel state information (CSI) report frames through a single link or multiple links respectively and the ACSI request frame comprises information indicating a number of CSI report on the single link or each link in the multiple links, and send the plurality of CSI report frames to the second wireless communication device according to the ACSI request frame through the single link or the multiple links respectively via the wireless transceiver.

19. The wireless communication device as claimed in claim 18, wherein the ACSI request frame further comprises time information for indicating time when the CSI report is sent on the corresponding link and the information for indicating a number of CSI report sent on the corresponding link, wherein time information comprises a target time when a first CSI report frame is sent on the corresponding link, a time interval between two consecutive CSI report frames on the corresponding link; and
wherein the ACSI request frame further comprises at least one of a number of streams field, bandwidth (BW) field, Modulation and Coding Scheme (MCS) field, wherein the number of streams field comprises a value indicating the number of streams for transmitting each CSI report frame on the corresponding link, the BW field comprises a value indicating the BW used by the second wireless communication device for transmitting each CSI report frame on the corresponding link, and the MCS field include a value indicating the MCS rate for transmitting each CSI report frame on the corresponding link.

20. The wireless communication device as claimed in claim 18, wherein the multiple links comprise a first link, a second link and a third link, and the plurality of CSI report frames are sent to the second wireless communication device cyclically in an order of the first link, the second link, and the third link.
